(19) United States
(12) Patent Application Publication
(10) Pub. No.: US 2008/0130691 A1
(43) Pub. Date: Jun. 5, 2008

(54) Microsoft Windows BDA Digital Signal Processing System and Processing Method Thereof

(75) Inventors: Manu CHEN, Chung Ho City (TW); Yi-Kuei LEE, Chung Ho City (TW)

Correspondence Address: LOWE HAUPTMAN HAM & BERNER, LLP, 1700 DIAGONAL ROAD, SUITE 300, ALEXANDRIA, VA, 22314, US

(73) Assignee: AVERMEDIA TECHNOLOGIES, INC., Chung Ho City (TW)

(21) Appl. No.: 11/622,743

(22) Filed: Jan. 12, 2007

(30) Foreign Application Priority Data
Dec. 1, 2006 (TW) 95144785

(51) Int. Cl. H04J 3/22; H04J 3/04

(52) U.S. Cl. 370/536; 370/465

(57) ABSTRACT

A Microsoft Windows BDA digital signal processing system includes a multimedia-processing device for processing a plurality of analog data packets and outputting a digital stream. A splitter receives and duplicates the digital stream to output a first digital stream and a second digital stream. A demultiplexer receives the first digital stream. When the first digital stream is a transport stream, then the demultiplexer demutlitplexes the first digital stream. A non-transport stream controller receives the second digital stream. When the second digital stream is a non-transport stream, then the non-transport stream controller processes the second digital stream. A processing method using the foregoing Microsoft Windows BDA digital signal processing system is also provided.

### RELATED APPLICATIONS

The present application is based on, and claims priority from, Taiwan Application Serial Number 95144785, filed Dec. 1, 2006, the disclosure of which is hereby incorporated by reference herein in its entirety.

### BACKGROUND OF THE INVENTION

1. Field of Invention

The invention relates to a Microsoft Windows BDA digital signal processing system and the method thereof. In particular, the invention relates to a Microsoft Windows BDA digital signal processing system that can process a non-transport stream and the method thereof.

2. Related Art

In view of the coming broadband network, Microsoft has proposed a DirectShow application with high flexibility and supporting MPEG-2 streams on the Microsoft Windows platform. It is designed to satisfy the requirements for high-quality multimedia.

FIG. 1 is a schematic view of the Microsoft Windows BDA digital signal processing system 100 in the prior art. As shown in the drawing, a digital broadcasting signal supplier 110 transmits several analog data packets 114 to a multimedia processing device 120. The multimedia processing device 120 includes a tuner 122, a demodulator 124, and a capture 126, for processing the analog data packets 114 and outputting a digital stream 128. The digital stream 128 can be a transport stream. The digital stream 128 is also transmitted to a transport stream multiplexer 130. The analog data packets 114 can be DVB-T or ATSC digital signals.

In the DirectShow plot, the tuner 122, the demodulator 124, and the capture 126 represent control nodes of DirectShow. The transport stream demultiplexer 130 is used to demultiplex the digital stream 128 in the transport stream, generating a signal comprising images, voices, or other multimedia information.

The above-mentioned Microsoft Windows BDA digital signal processing system 100 has only the abilities to receive and output transport streams. If the analog data packet 114 has DVB-H digital signals, then the digital stream 128 can be a non-transport stream. However, the transport stream demultiplexer 130 cannot process non-transport streams. Therefore, it is necessary to provide a Microsoft Windows BDA digital signal processing system that can receive non-transport streams.

### SUMMARY OF THE INVENTION

An objective of the invention is to provide a Microsoft Windows BDA digital signal processing system that can receive analog data packets for processing both transport and non-transport streams.

In accord with the above-mentioned objective, the disclosed Microsoft Windows BDA digital signal processing system includes a multimedia processing device for receiving and processing several analog data packets and outputting a digital stream; a splitter for receiving and duplicating the digital streams and generating a first digital stream and a second digital stream that are identical to the digital stream; a transport stream demultiplexer for receiving the first digital stream and demultiplexing it if it is a transport stream; and a non-transport controller for receiving the second digital stream and processing it if it is a non-transport stream.

More explicitly, when the second digital stream is a non-transport stream, the non-transport stream controller can save, demultiplex, or parse it. For example, the non-transport stream controller can transmit the second digital stream to a storage device or to a conversion filter, demultiplex and transmit it to a conversion filter, or demultiplex and parse it and transmit it to a conversion filter.

The multimedia processing device further includes a tuner, a demodulator, and a capture for receiving and processing analog data packets and outputting the digital stream. The non-transport controller is a DirectShow filter. The transport stream is in the MPEG-2 format. In accord with the above-mentioned objective, the disclosed Microsoft Windows BDA digital signal processing method includes the steps of: receiving several analog data packets; processing the analog data packets to generate a digital stream; duplicating the digital stream to generate a first digital stream and a second digital stream that are identical to the digital stream; and transmitting the first digital stream to a transport stream demultiplexer and transmitting the second digital stream to a non-transport stream controller; wherein the transport stream demultiplexer demultiplexes the first digital stream when it is a non-transport stream, and the non-transport controller demultiplexes and parses the second digital stream when it is a non-transport stream.

More explicitly, when the second digital stream is a non-transport stream, the non-transport stream controller can save, demultiplex or parse it. For example, the non-transport stream controller can transmit the second digital stream to a storage device, demultiplex and transmit the second digital stream to a conversion filter when it is a non-transport stream, or demultiplex, parse, and transmit the second digital stream to a conversion filter when it is a non-transport stream.

The non-transport stream controller is a DirectShow filter. The transport stream is in the MPEG-2 format.

The disclosed Microsoft Windows BDA digital signal processing system and method use DirectShow to construct a non-transport stream controller for processing non-transport streams. Therefore, the invention is built under a single driver, which makes it easier for development and debugging.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view showing the conventional Microsoft Windows BDA digital signal processing system;

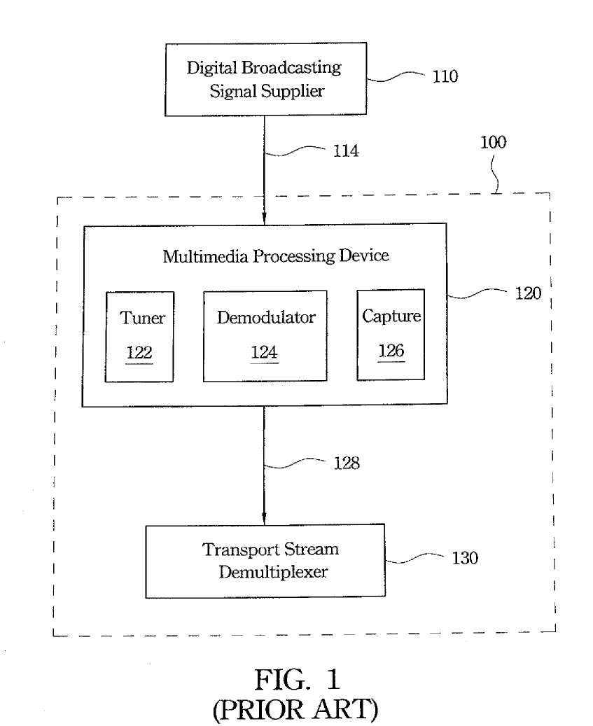

FIG. 2 is a schematic view showing the Microsoft Windows BDA digital signal processing system according to a preferred embodiment of the invention; and

FIG. 3 is a schematic view showing the Microsoft Windows BDA digital signal processing method according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

The disclosed Microsoft Windows BDA digital signal processing system and method use DirectShow to construct a non-transport stream controller for processing non-transport streams. The present invention will be apparent from the following detailed description, which proceeds with reference to the accompanying drawings, wherein the same references relate to the same elements.

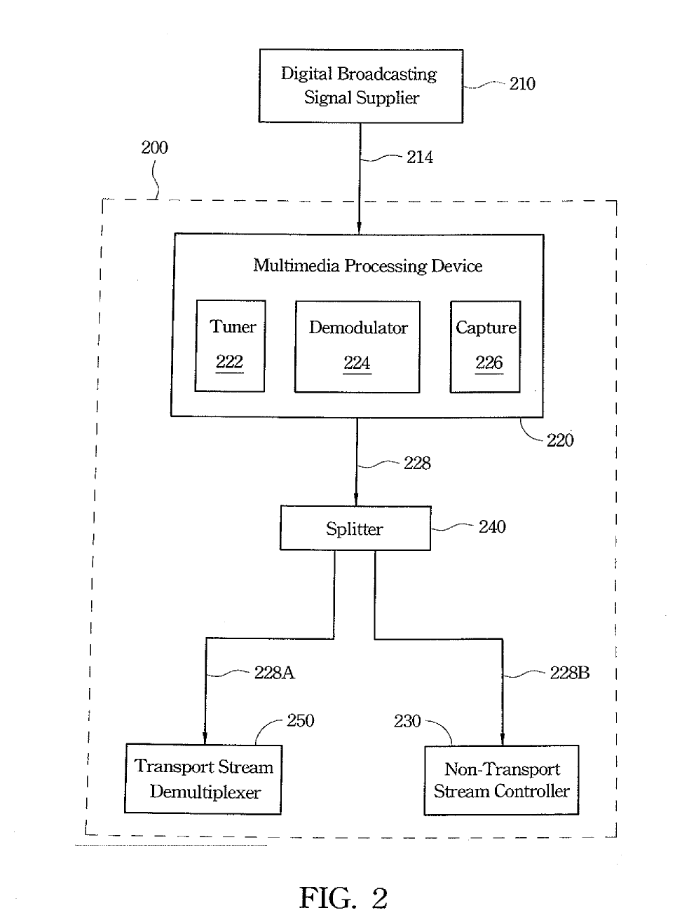

With reference to FIG. 2, the digital signal processing system 200 contains a multimedia processing device 220, a splitter 240, a transport stream multiplexer 250, and a non-transport stream controller 230. The digital broadcasting signal supplier 210 transmits several analog data packets 214 to the multimedia processing device 220. The multimedia processing device 220 is used to receive and process the analog data packets 214 and to output a digital stream 228. The splitter 240 receives the digital stream 228 transmitted from the multimedia processing device 220, duplicates the digital stream 228 and generates a first digital stream 228A and a second digital stream 228B that are identical to the digital stream 228. The transport stream multiplexer 250 receives the first digital stream 228A. When the first digital stream 228A is a transport stream, the transport stream demultiplexer 250 demultiplexes it. The non-transport stream controller 230 is used to receive and process the second digital stream 228B. The transport stream can be in the MPEG-2 format.

The multimedia processing device 220 includes a tuner 222, a demodulator 224, and a capture 226 for receiving and processing analog data packets 214 and outputting digital streams 228. The non-transport stream controller 230 is a DirectShow filter. Any person skilled in the art knows that the core of DirectShow uses the modularized and plug-in architecture. Moreover, DirectShow is based on the Component Object Model (COM). Therefore, one can use the interface provided by COM on the tuner 222, demodulator 224, and capture 226 that are compatible with DirectShow to process analog data packets 214 and output digital streams 228.

When the second digital stream 228B is a non-transport stream, the non-transport stream controller 230 processes the non-transport streams according to needs. In this case, the non-transport stream controller 230 can save, demultiplex, or parse the second digital stream. For example, the non-transport stream controller 230 transmits the second digital stream 228B to a storage device (not shown) or to a conversion filter (not shown), demultiplexes the second digital stream 228B and transmits it to a conversion filter (not shown), or demultiplexes and parse the second digital stream 228B and transmits it to a conversion filter (not shown). Any person skilled in the art knows that the conversion filter receives the data output by the non-transport stream controller 230. When the second digital stream 228B is a transport stream, then the non-transport stream controller can opt not to process the transport stream. When the first digital stream 228A is a transport stream, then the transport stream demultiplexer 250 demultiplexes it to generate a signal containing images, voices or other multimedia information. When the first digital stream 228A is a non-transport stream, then the transport stream demultiplexer 250 can opt not to process it.

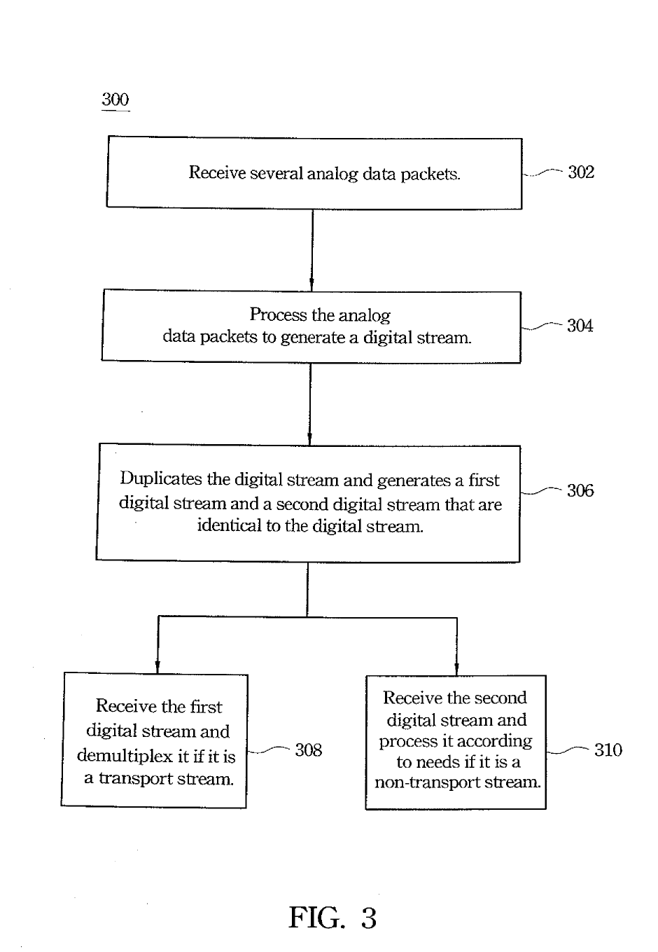

With simultaneous reference to FIGS. 2 and 3, the disclosed Microsoft Windows BDA digital signal processing method 300 involves the following steps. In step 302, the multimedia processing device 220 receives several analog data packets 214. In step 304, the multimedia processing device 220 processes the analog data packets 214 to generate a digital stream 228. In step 306, the digital stream 228 is duplicated to generate a first digital stream 228A and a second digital stream 228B that are identical to the digital stream 228. The first digital stream 228A is sent to a transport stream demultiplexer 250, and the second digital stream 228B is sent to a non-transport controller 230. In step 308, if the first digital stream 228A is a transport stream, then the transport stream demultiplexer 250 demultiplexes it. If the first digital stream 228A is a non-transport stream, then the transport stream demultiplexer 250 can opt not to process the first digital stream 228A. In step 310, if the second digital stream 228B is a non-transport stream, the non-transport stream controller 230 processes it according to needs. The non-transport stream controller 230 is a DirectShow filter. If the second digital stream is a non-transport stream, then the non-transport stream controller can save, demultiplex, or parse the second digital stream. For example, when the second digital stream 228B is a non-transport stream, the non-transport stream controller 230 transmits the second digital stream 228B to a storage device (not shown) or to a conversion filter (not shown), demultiplexes the second digital stream 228B and transmits it to a conversion filter (not shown), or demultiplexes and parse the second digital stream 228B and transmits it to a conversion filter (not shown). When the second digital stream 228B is a transport stream, then the non-transport stream controller 220 can opt not to process it.

More explicitly, in the step where the multimedia processing device 220 processes the analog data packets 214, a tuner 222, a demodulator 224, and a capture 226 are employed to output the digital stream 228. The non-transport stream controller 230 is a DirectShow filter. The transport stream is in the MPEG-2 format.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Microsoft Windows BDA digital signal processing system, comprising:
a multimedia processing device for receiving and processing a plurality of analog data packets and outputting a digital stream;
a splitter for receiving and duplicating the digital stream, generating a first digital stream and a second digital stream that are identical to the digital stream;
a transport stream demultiplexer for receiving the first digital stream and demultiplexing it when it is a transport stream; and
a non-transport stream controller for receiving the second digital stream and processing it when it is a non-transport stream.

2. The system of claim 1, wherein the multimedia processing device includes a tuner, a demodulator, and a capture for receiving and processing the analog data packets to obtain the digital stream.

3. The system of claim 1, wherein the non-transport stream controller is a DirectShow filter.

4. The system of claim 1, wherein the transport stream is in the MPEG-2 format.

5. The system of claim 1, wherein the non-transport stream controller transmits the second digital stream to a storage device when it is a non-transport stream.

6. The system of claim 1, wherein the non-transport stream controller transmits the second digital stream to a conversion filter when it is a non-transport stream.

7. The system of claim 1, wherein the non-transport stream controller demultiplexes the second digital stream and transmits it to a conversion filter when it is a non-transport stream.

8. The system of claim 1, wherein the non-transport stream controller demultiplexes and parses the second digital stream and transmits it to a conversion filter when it is a non-transport stream.

9. A Microsoft Windows BDA digital signal processing method, comprising the steps of:
receiving a plurality of analog data packets;
processing the analog data packets to generate a digital stream;
duplicating the digital stream to generate a first digital stream and a second digital stream that are identical to the digital stream;
transmitting the first digital stream to a transport stream demultiplexer and transmitting the second digital stream to a non-transport stream controller;
wherein the transport stream demultiplexer demultiplexes the first digital stream when it is a transport stream, and the non-transport stream controller processes the second digital stream when it is a non-transport stream.

10. The method of claim 9, wherein the non-transport stream controller is a DirectShow filter.

11. The method of claim 9, wherein the transport stream is in the MPEG-2 format.

12. The method of claim 9, wherein the non-transport stream controller transmits the second digital stream to a storage device when it is a non-transport stream.

13. The method of claim 9, wherein the non-transport stream controller transmits the second digital stream to a conversion filter when it is a non-transport stream.

14. The method of claim 9, wherein the non-transport stream controller demultiplexes the second digital stream and transmits it to a conversion filter when it is a non-transport stream.

15. The method of claim 9, wherein the non-transport stream controller demultiplexes and parses the second digital stream and transmits it to a conversion filter when it is a non-transport stream.
